(19) United States
(12) Patent Application Publication
(10) Pub. No.: US 2026/0083054 A1
(43) Pub. Date: Mar. 26, 2026

(54) SYSTEM AND METHOD FOR DETERMINING A SENSOR POSITION IN A SEPARATOR OF A HARVESTER

(71) Applicant: CLAAS Selbstfahrende Erntemaschinen GmbH, Harsewinkel (DE)

(72) Inventors: Marvin Barther, Steinhagen (DE); Sergej Neufeld, Paderborn (DE); Waldemar Thiesmann, Osnabrück (DE); Christoph Högemeier, Osnabrück (DE); Bastian Bormann, Gütersloh (DE); Johann Witte, Fröndenberg (DE)

(73) Assignee: CLAAS Selbstfahrende Erntemaschinen GmbH, Harsewinkel (DE)

(21) Appl. No.: 19/335,271

(22) Filed: Sep. 22, 2025

(30) Foreign Application Priority Data
Sep. 23, 2024 (DE) 10 2024 127 437.9

(51) Int. Cl. A01D 41/127; G01D 11/24; G01M 99/00

(52) U.S. Cl. CPC A01D 41/127; G01D 11/245; G01M 99/008

(57) ABSTRACT

A method for determining a sensor position in a separating device of a harvester, a sensor system, and a harvester. The method includes: accessing a separation function configured to determine a calculated separation; and determining a sensor position for at least one sensor for detecting an actual separation in that a respective position is determined in the separating device at which the separation function has a maximum sensitivity.

### CROSS REFERENCE TO RELATED APPLICATION

This application claims priority under 35 U.S.C. § 119 to German Patent Application No. DE 10 2024 127 437.9 filed Sep. 23, 2024, the entire disclosure of which is hereby incorporated by reference herein.

### TECHNICAL FIELD

The present invention relates to a method for determining a sensor position in a separating device of a harvester, a sensor system for detecting measured values in a separating device of a harvester, and a harvester comprising a separating device and a sensor system.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Separating devices or separating mechanisms may be equipped with sensors for detecting actual separation. For example, EP 4 151 072 A1 discloses a separating device for a combine harvester with a sensor device having at least one grain sensor. The grain sensor is arranged or positioned inside and/or outside the separation unit in such a way that a quantity separated using the separation unit and/or a quantity of grains contained in the harvested material conveyed in the intermediate space may be determined at least along the longitudinal axis of the separation unit from the inlet region to the outlet region of the separation unit in places without impairing the harvested material flow.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a schematic representation of a method for determining a sensor position in a separating device of a harvester according to one embodiment.

FIG. 2 illustrates a schematic representation of a harvester according to one embodiment.

FIG. 3 illustrates a separating device of the harvester in a perspective view according to one embodiment.

FIG. 4 illustrates a separation function according to one embodiment.

FIG. 5 illustrates a sensor system configured to detect measured values in a separating device of a harvester according to one embodiment.

### DETAILED DESCRIPTION

As discussed in the background, EP 4 151 072 A1 discloses a separating device for a combine harvester with a sensor device having at least one grain sensor. In one or some embodiments, the sensor system may be configured to determine the position of the sensor or grain sensor precisely.

Thus, in one or some embodiments, a method is disclosed that is configured to determine the sensor position, such as an efficient determination of the sensor position. In particular, in one or some embodiments, a method is disclosed for determining the sensor position in a separating device of a harvester. The method may comprise: providing and/or accessing a separation function for determining a calculated separation; and determining a sensor position for at least one sensor for detecting an actual separation. The sensor position may be determined based on the separating function, such as by determining a position in the separating device at which the separation function has maximum sensitivity.

A harvester may be an agricultural work machine that is specifically designed for harvesting crops. The harvester may be, for example, a combine harvester with a separating device. The separating device may be designed or configured to separate harvested material. In the separating device, grains and cars that have not been completely threshed may be separated from the straw. The separating device may also at least partially thresh the harvested material. The separating device may have a basket segment (also called a basket region) for separating components from the harvested material. The basket segment or basket region may be designed as a sheet metal basket, wire basket, or finger basket. The loss of the harvester may refer to a quantity of harvested material that remains unused, is damaged or is otherwise lost during the use of the harvester. The loss may, for example, be a loss of grain. The loss or grain loss may occur during the separation of harvested material in the separating device.

The separation of harvested material may be understood as the separation of grain and non-grain components, such as chaff and straw, from the harvested material. Separation using the basket segment may take occur during separation in the separating device. The processes of segregation and separation may occur in the separating device. Segregation may occur when the different components behave differently during separation in the separating device due to their physical properties. For example, heavier particles may sink faster, while lighter particles may remain higher up. Separation may also describe how different particles arrange or accumulate on the basket segment due to their different properties. Separation may refer to a process in which components of the harvested material are separated in the separating device via the basket segment. The separated harvested material (e.g., the grain) may leave the separating device after separation and be collected in a grain tank, for example. The harvester may have at least one separating device. It is also contemplated for the harvester to have a plurality of separating devices.

In one or some embodiments, the separation function may comprise a mathematical model or a mathematical representation that describes or is indicative of the separation (e.g., the separation efficiency or the amount of separated harvested material) depending on the path within a separation process or a separating device. The separation function may include function parameters (also referred to as coefficients) that determine the course of the separation function. Using the separation function, a theoretical or calculated separation at a specified position or location in the separating device may be determined. The separation function may describe or determine any one, any combination, or all of a separation value, degree of separation, or separation curve.

Using the separation function, the (calculated) separation of harvested material may be determined along a conveying direction of the separating device (e.g., the calculated separated harvested material (for example, grain) may be determined at each point or geometric coordinate of the separating device).

The sensor for detecting actual separation may be designed or positioned so that it is assigned to the separating device in its harvested material-separating region as a separation sensor. The sensor may, for example, generate a signal corresponding to or indicating the amount of separated harvested material. This signal may then be transmitted (e.g., wired and/or wirelessly) to an evaluation unit (e.g., a controller, processor or the like) for further processing. The sensor may comprise a grain sensor that is arranged or positioned in the separating device of a combine harvester.

The sensitivity may be a fluctuation or variability in the separation rate of the separation function due to various factors. The sensitivity may describe or indicate how susceptible the separation rate is to various factors. These factors may, for example, be differences in material flow, harvesting conditions, or other operating conditions. A high sensitivity may indicate that small changes in these factors may lead to larger fluctuations in the separation rate.

The maximum sensitivity of the separation function may be assigned to a point or range at which the sensor exhibits the highest sensitivity to changes in the amount of separated harvested material. Any discussion herein regarding the point of maximum sensitivity includes a specific point or includes a specific range. Further, any discussion regarding range may include a specific point. Viewed mathematically, this may be, for example, the point at which the derivative of the separation function has a zero value. The maximum sensitivity of the separation function may be assigned to the point or range at which the separation function may be most strongly influenced by adjusting the measured values detected by the sensor. The maximum sensitivity of the separation function may also be defined as the range in which the separation function shows the greatest change when the function parameters or coefficients of the separation function vary. At this point, the sensor may respond most strongly to small changes in the separation quantity, which may enable precise and detailed monitoring.

In other words, the method may enable a sensor position to be determined at which the (actual and/or calculated) separation by the separating device may be determined particularly precisely and with low measurement noise using the sensor and the separation function. In turn, the sensor position that is determined may then be used in operation of the at least one sensor (e.g., the position of the sensor is then placed (manually or automatically) based on the sensor position determined, such as identically at the sensor position determined, or substantially at the sensor position determined (e.g., within 10% of the sensor position determined, within 5% of the sensor position determined, etc.). After which, during operation of the combine, the sensor (placed based on the sensor position) may be used for operation of the combine (such as automatic operation of the combine).

The separation function, which has been adjusted based on the measured values detected at the sensor position, may enable particularly precise calculations of the theoretical separation. This may, for example, contribute to the improvement of the efficiency and accuracy of the harvesting process in that it may be ensured that separation losses are monitored more precisely and reliably. Using the sensor located at the sensor position, measurement data may be detected that is used to adjust the separation function during ongoing operation of the harvester. The separation function may be used to calculate separation losses. In other words, the separation losses may be calculated better or more accurately based on the specific sensor position.

In a further aspect, the separating device may comprise a rotor and a rotor jacket. The method may further comprise providing a measuring line, wherein the measuring line is arranged or positioned on the rotor jacket of the separating device. Furthermore, the method may comprise determining the sensor position of the at least one sensor. The sensor position may be determined in that a position is determined on the measuring line at which the separation function has maximum sensitivity.

Using the rotor, the harvested material flow may be conveyed in a substantially helical motion. In doing so, the harvested material flow may move in two directions simultaneously. The harvested material flow may rotate about an axis (e.g., the main axis of the rotor or the rotor axis) and simultaneously move along this axis, whereby a three-dimensional spiral path may be created. By rapid rotation of the rotor, the grain may be ejected and separated from the straw by centrifugal forces. The rotor shell may enclose the rotor.

The measuring line may be a defined line or distance along which measurements may be taken. The measuring line may serve as a reference or reference point on which a sensor may be positioned to detect the actual separation. Accordingly, in one or some embodiments, the determination of the sensor position may occur from only one dimension, namely along the measuring line In other words, the determination of the sensor position may be reduced to one dimension along the measuring line. The measuring line may lie on the rotor jacket so that it may thereby be determined that the sensor is also located on the rotor jacket. By positioning the sensor along the measuring line at the point of maximum sensitivity, the measurements may made much more accurately. This may allow the determination of the sensor position to be optimized and made more efficient.

In a further aspect, the rotor may have a rotor axis, and the measuring line may be arranged or positioned substantially parallel (e.g., at least 90%, at least 95%, at least 96%, at least 97%, at least 98%, or at least 99%) to the rotor axis. Alternatively, the measuring line may be arranged or positioned parallel to the rotor axis.

If the measuring line runs substantially parallel to the rotor axis, this may ensure faster determination of the sensor position. In other words, the measuring line, the rotor axis, and the direction of conveyance by the separating device may be arranged or positioned substantially parallel to each other. This may allow, for example, step-by-step checking along the measuring line or rotor axis to determine the point at which maximum sensitivity is achieved.

In a further aspect, the rotor jacket may have a drop step. The method may include determining a drop step position based on the sensor position. The drop step position may be determined using a drop function, wherein the drop function may be determined from the separation function.

The drop step may be a recess in the rotor jacket into which the harvested material may fall. This may allow the harvested material to be optimally detected by the sensor, which may be positioned in the drop step. In other words, the drop step may ensure that the harvested material does not slip past the sensor but falls directly onto it and may thus be detected. Such an arrangement may increase the efficiency of the entire harvesting process in that measurement errors would be minimized and the sensor would need to be readjusted less frequently.

The drop step position may be the position of the sensor in the drop step. The drop function may be a mathematical or algorithmic representation that determines the optimal position and depth of the drop step in the rotor jacket. The drop function may be derived based on the separation function, which may describe the behavior and separation of the harvested material during the process. The drop function may take into account how the harvested material is affected by centrifugal and gravitational forces to ensure that it enters the drop step efficiently and is detected by the sensor. The aim may be to design the drop step or drop step position in such a way that detection by the sensor is maximized and the accuracy of the measurements is increased.

In another aspect, the method may include determining whether the sensor position lies within the rotor jacket or outside the rotor jacket.

Inside the rotor jacket may mean that the sensor is located directly in the region of the rotor where the harvested material is processed by the centrifugal movement. In this case, the sensor may be integrated into the structure of the rotor jacket and detect the harvested material during rotation. Outside the rotor jacket may mean that the sensor is possibly positioned outside the rotating structure. In this case, the sensor may detect the harvested material after it has left the rotor jacket (e.g., after separation) or through openings in the jacket.

In another aspect, the rotor jacket may comprise a protective housing to protect the sensor system. In this case, determining the sensor position may take into account the position of the protective housing.

The protective housing may specifically serve to protect the sensor system from mechanical damage, contamination, or other external influences. The protective housing may, for example, be a drop grid that covers the drop step. The drop grid may have the function of guiding the harvested material and at the same time protecting the sensor from direct contact with larger particles or foreign objects. While the harvested material falls through the drop grid, it may possibly still be detected by the sensor, which may ensure accurate measurement. When determining the optimal sensor position, it may be crucial to take into account the position and structure of the protective housing. The sensor may potentially need to be positioned so that it may perform precise measurements despite the protection provided by the protective housing. This may mean that the distance between the sensor and the drop grid and the openness of the drop grid are designed so that they do not impair the sensor function.

In a further aspect, the method may include determining a harvested material flow line in the separating device. In this case, harvested material may be separable in sections along the harvested material flow line. Furthermore, the method may include providing the separation function based on the harvested material flow line. In addition, the method may include determining the sensor position. The sensor position may be determined in that a position on the harvested material flow line is determined at which the separation function has maximum sensitivity.

The harvested material flow line may designate the path or route that the harvested material passes through in the separating device. The harvested material flow line may be a region along which harvested material may flow. The harvested material flow line may describe the entire transport process of the harvested material through the various mechanical components of the separating device. In other words, the harvested material flow line may be a line along which the majority of the harvested material or a center of gravity of the harvested material flow moves. The harvested material flow line may be determined, for example, by determining the entry of the harvested material into the separating device and projecting the further course of the harvested material flow based on the geometric and mechanical conditions in the separating device. For example, using the speed and mass of the harvested material as it enters the separating device, it may be determined which mechanical forces act on the harvested material during the subsequent course through the separating device. This may also allow the geometric points to be determined at which the harvested material or a large part of the harvested material will be located in the separating device at specific points in time. Based on these geometric points, a projection line or a harvested material flow line may be determined. At one, some, or each point of the harvested material flow line, it may be possible to determine a value for the separation and, in summary, therefore a separation curve.

Another aspect relates to a sensor system configured to detect measured values in a separating device of a harvester. The sensor system may comprise at least one sensor, wherein the sensor position of the at least one sensor may be determined according to one of the preceding aspects (e.g., access a separation function configured to determine a calculated separation; and determine sensor position of the at least one sensor by determining a position in the separating device at which the separation function has a maximum sensitivity).

A further aspect relates to a harvester, wherein the harvester may comprise a separating device and a sensor system according to one of the preceding aspects.

Furthermore, the harvester may comprise an evaluation unit. The evaluation unit may be provided and configured to perform (such as automatically perform) the method described herein in whole or in part.

In a further aspect, the separating device may comprise a rotor and a rotor jacket. Furthermore, the rotor jacket may comprise a drop step. The rotor jacket may comprise a protective housing for protecting the sensor system.

It is understood that the aforementioned features and those to be explained below are usable not only in the combination indicated in each case, but also in other combinations or on their own, without departing from the scope of the present invention.

It will be apparent to a person skilled in the art that the presented methods may be implemented or saved in the form of instructions in software or on a computer program product, wherein saved instructions enable the steps according to the method to be performed when a corresponding data processing machine is controlled by the software. In other words, it is possible for the methods to be computer-implemented methods. This means that it is possible that an aspect relates to a computer-implemented method for determining a loss by a harvester. The method steps may be partially or completely part of the computer-implemented method. Embodiments therefore also relate to a storage medium with software saved thereon, which is designed to perform the presented methods when the software is run on a data processing device. The method may be carried out offline and/or onboard (i.e., embedded and in real time).

In the following description, reference is made to the attached figures which are part of the disclosure and illustrate certain aspects and embodiments under which the present disclosure may be understood. Identical reference signs refer to identical or at least functionally or structurally similar features.

In general, a disclosure of a described method may also apply to a corresponding device for performing the method or a corresponding system that comprises one or more devices, and vice versa. For example, if a particular method step is described, a corresponding device may contain a feature for performing the described method step, even if this feature is not explicitly described or shown in the figure. On the other hand, if, for example, a particular device is described on the basis of functional units, a corresponding method may contain one or more steps for performing the described functionality even if these steps are not explicitly described or shown in the figures. Similarly, a system may include a corresponding device feature or features for performing a particular step of the method. The features of the various exemplary aspects and embodiments described above or below may be combined, provided that something different is not explicitly stated.

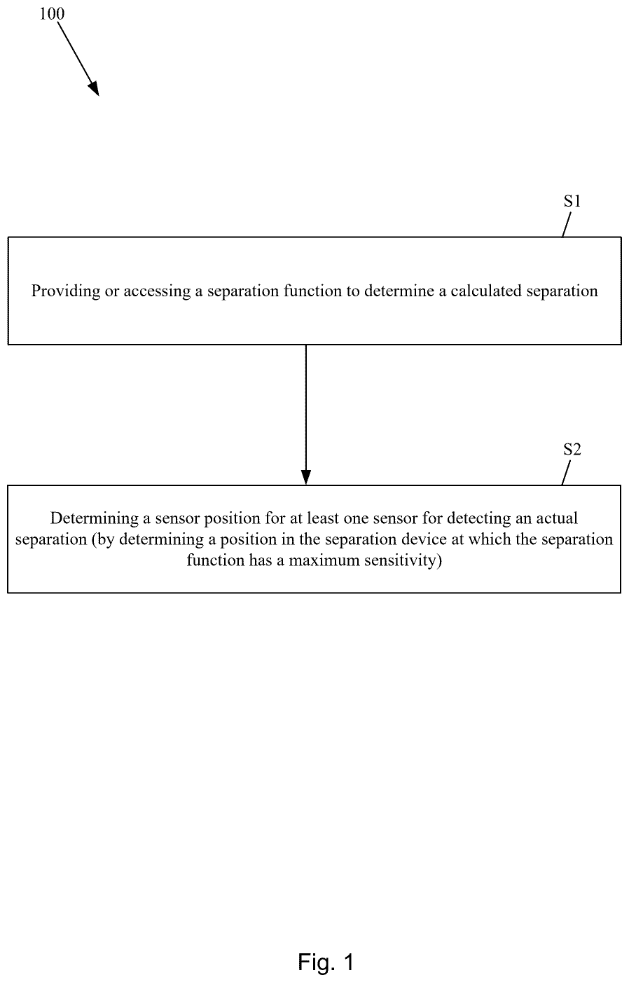

Referring to the figures, FIG. 1 shows a schematic representation of a method 100 for determining a sensor position in a separating device of a harvester according to one embodiment.

In step S1 of the method, a separation function may be provided or accessed to determine a calculated separation. In a further step S2, a sensor position for at least one sensor (for detecting an actual separation) may be determined (e.g., the sensor position may be determined by, in the separating device, the position at which the separation function has maximum) sensitivity. Step S2 may alternatively be expanded or modified.

In a first alternative, a measuring line may be provided or determined in one step, wherein the measuring line is arranged or positioned on the rotor jacket of the separating device. Then, in a further step, the sensor position of the at least one sensor may be determined by analyzing the position along the measuring line (e.g., the position may be determined as the position on the measuring line at which the separation function exhibits maximum sensitivity).

In a second alternative, a harvested material flow line may be determined in the separating device in a step, wherein harvested material may be separated in sections along the harvested material flow line. The separating function may then be provided or analyzed based on the harvested material flow line. Furthermore, the sensor position may then be determined as being a position on the harvested material flow line at which the separation function has maximum sensitivity.

Alternatively, during step S2, it may be determined whether the sensor position lies in the rotor jacket or outside the rotor jacket.

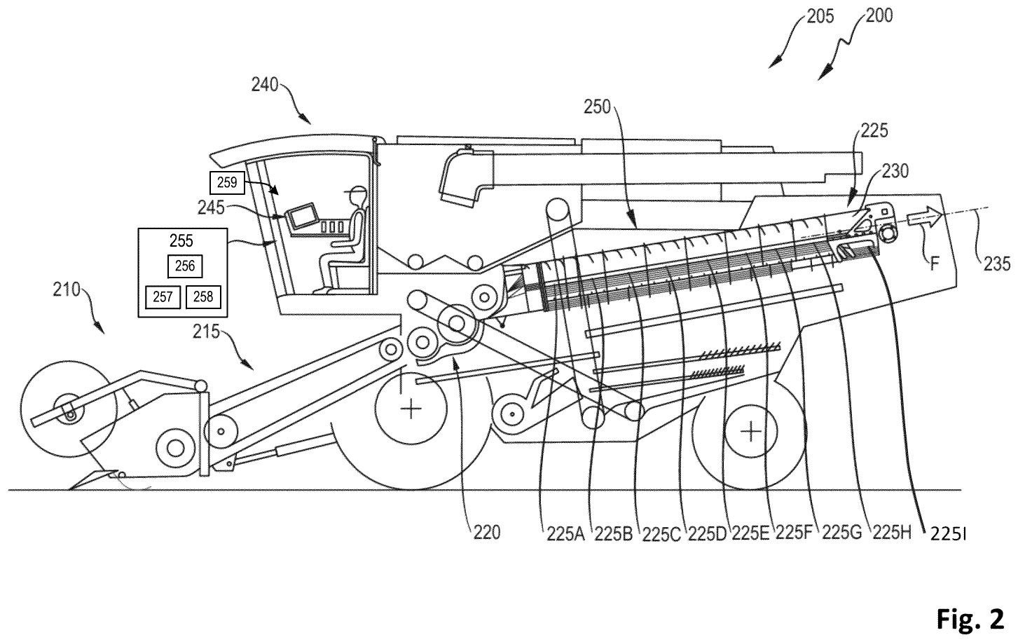

FIG. 2 shows a schematic representation of a harvester 200 according to one embodiment. The harvester 200 may comprise a combine harvester 205. Examples of combine harvesters include U.S. Pat. No. 8,333,640, US Patent Application Publication No. 2020/0305352 A1, US Patent Application Publication No. 2022/0174873 A1, and US Patent Application Publication No. 2023/0397533 A1, each of which is incorporated by reference herein in their entirety.

The combine harvester 205 may accommodate or include a front attachment 210 designed as a cutting unit in its front region, which may be connected in a manner known per se to an inclined conveyor 215 of the combine harvester 205. A harvested material flow passing through the inclined conveyor 215 may be transferred from the inclined conveyor 215 to a threshing device 220 of the combine harvester 205. From the threshing device 220, an emerging partial harvested material flow, which may basically contain non-grain components such as chaff and straw, may be transferred to a separating device 225. A further partial harvested material flow, which basically may contain grains separated from the harvested material, may pass from the threshing device 220 onto a conveyor floor. In this regard, the cutting unit may be configured to cut crops, which may then be threshed by the threshing device 220 (e.g., beating the stalks to separate the edible grain (one partial harvested material flow) from the inedible parts (such as the chaff and straw, to create another partial harvested material flow)), and in which the separating device 225 may further process the another partial harvested material flow (which may contain the inedible parts). As discussed in more detail below, the separating device 225 may include at least one sensor that is configured to determine one or more aspects of the another partial harvested material flow (e.g., the quantity separated using the separation unit and/or a quantity of grains contained in the harvested material conveyed in the intermediate space). In turn, using the data sensed by the at least one sensor, one, some, or each of the following may be controlled (such as automatically controlled): the cutting unit; the threshing device 220 (e.g., automatically control the speed of the rotating threshing drums and/or concaves that beat the plant material); or the separating device 225 (e.g., automatically control the air flow and/or the screens). Examples of the threshing device 220 are disclosed in U.S. Pat. No. 8,231,447, US Patent Application Publication No. 2014/0194170 A1, and US Patent Application Publication No. 2024/0081182 A1, each of which are incorporated by reference herein in their entirety.

The separating device 225 has a rotor 230. Using the rotor 230, harvested material may be conveyed in a conveying direction F along a rotor axis 235 or main axis of the rotor 230. Furthermore, the harvested material flow may be moved in a substantially helical manner using the rotor 230.

The partial harvested material flow of the harvested material flow may be conveyed from the separating device 225 in such a way that freely movable grains contained in the partial harvested material flow are separated in the lower region of the separating device 225. Both the grains separated from the harvested material flow by the threshing device 220 and the separating device 225 may be fed to a cleaning apparatus via a returns pan and a conveyor floor. From the cleaning device, a cleaned grain flow may finally reach a grain tank of the combine harvester 205 via a conveyor apparatus.

Furthermore, the combine harvester 205 may have a driver's cab 240 in which at least one graphical user interface 245 (e.g., a touchscreen) is arranged or positioned, which is connected to a bus system of the combine harvester 205 (and through which the evaluation unit 255 may communicate via communication interface 258). A driver assistance system 259 may communicate with the graphical user interface 245 in a manner known per se via the bus system. Further, the graphical user interface 245 may be used to display the determined sensor position (e.g., by zooming in on an image indicating the determined sensor position and/or highlighting the determined sensor position using an overlay in the image or the like). Examples of the driver assistance system 259, which may be configured to automatically control one or more working parameters of the combine harvester 205, such as one or more working parameters of the cutting unit, the threshing device 220, or the separating device 225, are disclosed in US Patent Application Publication No. 20230397533 A1, US Patent Application Publication No. 20240065155 A1, US Patent Application Publication No. 20250057068 A1, and US Patent Application Publication No. 2025/0057079 A1, each of which are incorporated by reference herein in their entirety.

The combine harvester 205 may also comprise a sensor system 250 configured to detect measured values in the separating device 225 and an evaluation unit 255. In particular, the sensor system 250 may comprise one or more sensors, such as any one, any combination, or all of: a separation loss sensor; a cleaning loss sensor; a broken grain sensor; or a threshing loss sensor. The evaluation unit 255 may be designed to further process the measured values from the sensor system 250.

For example, the evaluation unit 255 may comprise computing functionality to further process the measured values from the sensor system 250, and may include at least one processor 256, at least one memory 257, and at least one communication interface 258. The driver assistance system 259 may likewise include at least one processor 256, at least one memory 257, and at least one communication interface 258 (either separately from evaluation unit 255 or as part of evaluation unit 255). The memory 257 may be configured to store information, such as the separation function 400, and/or data (e.g., sensor position SP), and/or computer-executable instructions stored on the tangible memory. Moreover, the communication interface 258 may be configured to communicate with devices external to the evaluation unit 255, such as graphical user interface 245, other electronic devices, or the like.

The processor 256 and the memory 257 may be in communication (e.g., wired and/or wirelessly) with one another. In one or some embodiments, the processor 256 may comprise a microprocessor, controller, PLA, or the like. Similarly, the memory 257 may comprise any type of storage device (e.g., any type of memory, such as RAM, ROM, or a combination thereof). Though the processor 256 and the memory 257 are depicted as separate elements, they may be part of a single machine, which includes a microprocessor (or other type of controller) and a memory. Alternatively, the processor 256 may rely on the memory 257 for all of its memory needs. The memory 257 may comprise a tangible computer-readable medium that include software that, when executed by the processor 256 is configured to perform any one, any combination, or all of the functionality described herein.

The processor 256 and the memory 257 are merely one example of a computational configuration for the electronic devices discussed herein. Other types of computational configurations are contemplated. For example, all or parts of the implementations may be circuitry that includes a type of processor, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

The separating device 225 may be divided, for example, into a plurality of separation zones 225A to 225I. In one or some embodiments, the sensor system 250 may have a sensor in at least one separation zone 225A to 2251 for detecting measured values. The sensor may, for example, be configured to generate sensor data indicative of detecting grains separated from the harvested material stream by the separating device 225.

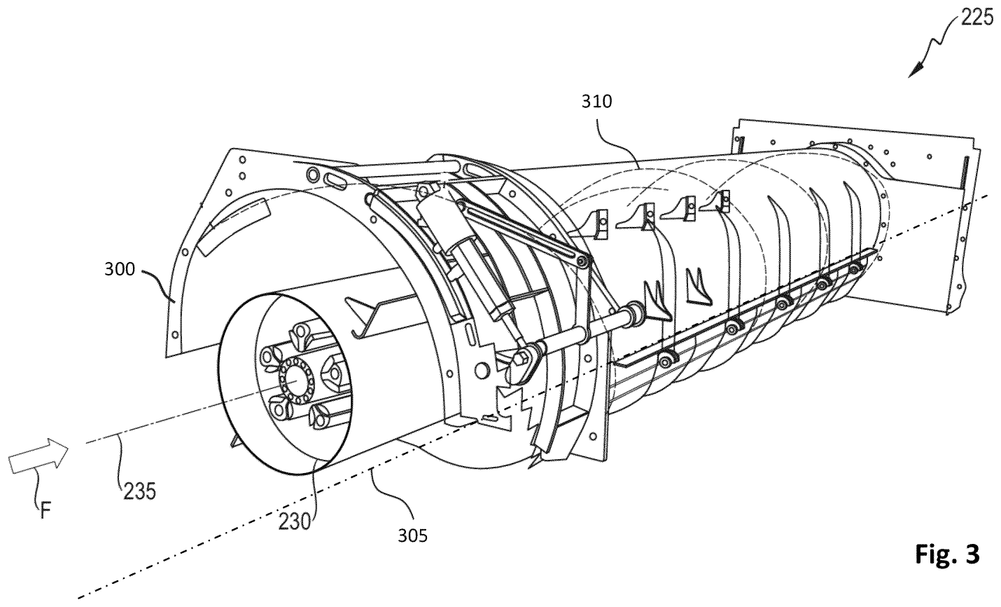

FIG. 3 illustrates the separating device 225 of the harvester 200 in a perspective view according to one embodiment. Harvested material may be conveyed using the rotor 230 along a conveying direction F, which may run parallel to a main axis or rotor axis 235 of the rotor 230. The harvested material or a center of gravity of the harvested material may thereby undergo a substantially helical movement (e.g., a movement that runs along a spiral path).

The rotor 230 may be enclosed by a rotor jacket 300. The rotor jacket 300 may have a jacket circumference and a jacket length. A basket region may form part of the rotor jacket 300. Components from the harvested material may be separated downwards in the basket region. The basket segment or basket region may be designed as a sheet metal basket, wire basket or finger basket.

The measuring line 305 may be arranged or positioned substantially parallel to the rotor axis 235. Furthermore, the measuring line 305 may be arranged or positioned on the rotor jacket 300 of the separating device 225. At least one sensor may be arranged or positioned at the position on the measuring line 305 at which the separating function has maximum sensitivity. The harvested material flow line 310 may be determined from a substantially helical movement of the harvested material flow conveyed by the rotor 230. The harvested material flow line 310 may correspond to a narrow track through the separating device 225. A separation function may be provided, generated or accessed, with the separation function being based on the harvested material flow line 310 (e.g., the separation function may describe the calculated separation along the harvested material flow line 310). A sensor position may be the position on the harvested material flow line 310 at which the separation function has maximum sensitivity.

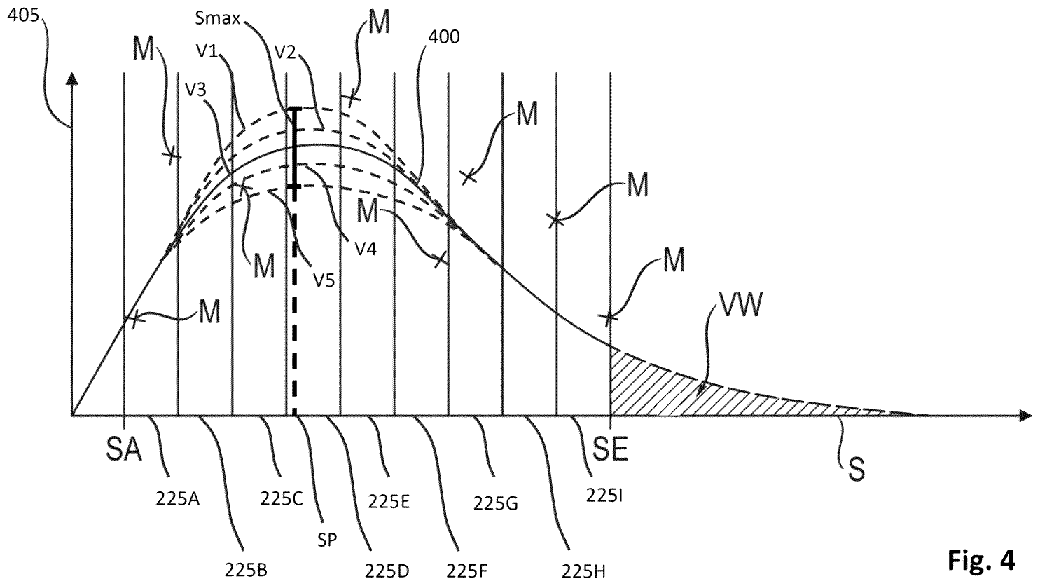

FIG. 4 illustrates the separation function 400 according to one embodiment. The separation function 400 may exhibit exponential behavior depending on material properties and machine settings of the method 100 for the harvester 200, which may run to zero with infinite separation path s. By means of the (e.g., one-dimensional) separation function 400, a separation rate 405 or grain rate may be determined or calculated at a point on the separation path s. The separation path s may correspond to the measuring line 305. Accordingly, the separation function 400 may determine the separation for each of the separation zones 225A to 2251 of the separating device 225.

The separation function 400 may be formed based on an analytical approach from two exponential functions to describe the separation in one dimension (i.e., the separation path s). In so doing, the two processes of grain segregation (process A) and grain separation (process B) may occur, both of which were defined with exponential behavior in the separation line. With the residual grain function R(s), which may describe the remaining share of grains in both processes together as the separation path s, and the separation function Z(s), which may describe the current separation grain rate, the functions may be defined as follows:

$$\begin{matrix}R ( s ) = \frac{1}{B - A} ( {Be}^{- As} - {Ae}^{- Bs} ) \\ Z ( s ) = \frac{\partial 1 - R ( s )}{\partial s} = \frac{AB}{B - A} ( {e}^{- As} - {e}^{- Bs} )\end{matrix}$$

The separation coefficients A and B may describe the corresponding segregation strength (process A) and the separation strength (process B). In so doing, it may be assumed that at the start of separation, all grains are in process A and must first be segregated. It is contemplated for the sensor system 250 to record the measured values M_Betrieb in the separating device 225 during the operation of the method 100 of the harvester 200. Coefficients of the separation function 400 may be determined based on the measured values M_Betrieb. For example, the separation coefficients A and B may be determined by means of the method of least squares.

Using the separation function 400, a sensor position SP may be determined for at least one sensor for detecting actual (or measured) separation in the separating device 225. In so doing, the position Pmax of the separation function 400 at which the separation function 400 has a maximum sensitivity Smax may be determined. In one or some embodiments, responsive to determining the position Pmax of the separation function 400 at which the separation function 400 has a maximum sensitivity Smax, the sensor may be manually moved to the determined position Pmax. As one example, the manual movement may be performed while initializing the configuration of the combine harvester 205. As another example, the manual movement may be performed periodically. Alternatively, responsive to determining the position Pmax of the separation function 400 at which the separation function 400 has a maximum sensitivity Smax, the sensor may be automatically moved to the determined position Pmax (e.g., via a motor configured to move the sensor along at least one rail). Alternatively, multiple sensors may be placed at different positions, with a respective sensor being at (or closest to) the determined position Pmax may be used for generating the data regarding the separating device 225.

The maximum sensitivity Smax of the separation function 400 may be assigned to a point Pmax (or range) at which the separation function 400 may be most strongly influenced by adjusting the measured values detected by the sensor. For this purpose, the sensor position SP of the sensor may be determined by means of tests. If, for example, the separation function 400 is adapted to the measured values M that were determined in a test using different test sensors, the shape of the separation function 400 may be different depending on the measured values M. In a first case, the separation function 400 may have a first curve V1. If other measured values M are used, the separation function 400 may have the curves V2 to V5. Due to the different curves V1 to V5, a fluctuation or variability of the separation rate 405 may thus arise at a position Pmax of the separation function 400. This variability of the separation function 400 may be referred to as the sensitivity. Since the sensitivity at this position Pmax may be particularly high compared to the other positions, the sensitivity may be referred to as the maximum sensitivity Smax. In other words, the separation function 400 may react to the adjustment to the measured values at this point or position Pmax with maximum sensitivity Smax or reacts particularly sensitively. The maximum sensitivity Smax of the separation function 400 may also be determined in that the coefficients of the separation function 400 (e.g., separation coefficients A and B) are varied.

The position Pmax may be used to determine the sensor position SP. In the simplest case, the sensor position SP corresponds to the position Pmax. In the present case, a sensor position SP was determined that lies in the separation zone 225D of the separating device 225. At the sensor position SP, the sensor may possibly respond most strongly to small changes in the separation rate, which may enable precise and detailed monitoring.

In other words, the method may enable the sensor position SP to be determined at which the calculated separation by the separating device 225 may be determined particularly precisely using the separation function 400. The separation function 400, which has been adjusted on the basis of the measured values detected at the sensor position SP, may enable particularly precise calculations of the theoretical separation or separation rate 405. This may, for example, contribute to the improvement of the efficiency and accuracy of the harvesting process in that it may be ensured that separation losses are monitored precisely and reliably. Using the sensor located at the sensor position SP, measurement data may be detected that may be used to adjust the separation function 400 during ongoing operation of the harvester 200.

In one step, it is possible to extend the separation function 400 beyond a range defined by the separating device 225 in order to determine the separation loss. This may mean that the separation function 400 may be extrapolated beyond a range defined by the separating device 225, for example beyond a separation end SE. Furthermore, a loss value VW may be determined in order to determine the loss via the extended range of the separation function 400. In this case, a loss region may be formed using the integral of the separation function 400 from the separation end SE to infinity. In other words, the grain losses may be the integral over the grain losses of the individual separation tracks over the width of the separation region at the end of the separation. In one or some embodiments, the separation losses may be calculated better or more accurately due to the specific sensor position SP.

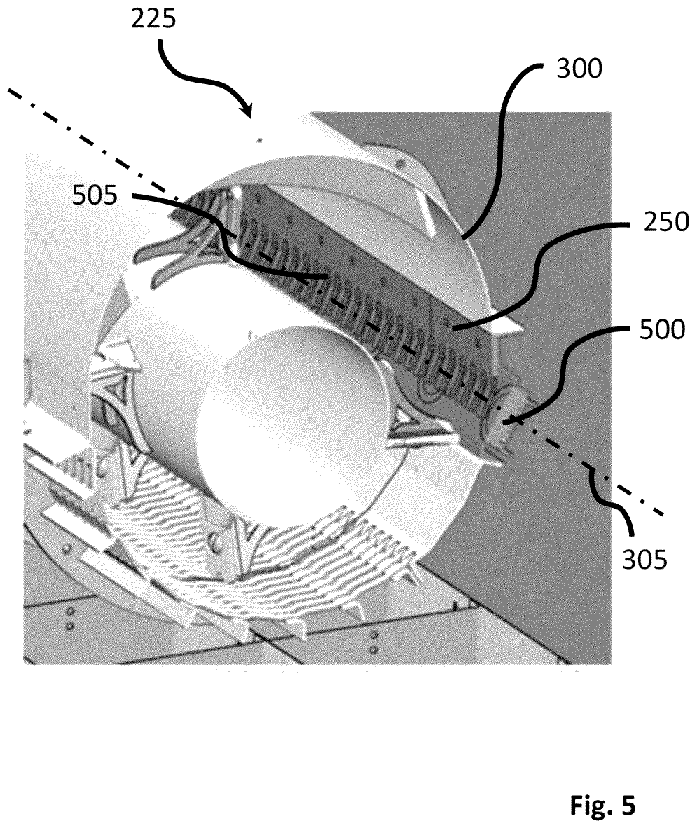

FIG. 5 shows a sensor system 250 for detecting measured values M_Betrieb in a separating device 225 of a harvester 200 according to one embodiment. The measured values M_Betrieb may be detected during operation of the harvester 200. The sensor system 250 comprises at least one sensor 500, wherein the sensor position SP of the at least one sensor 500 has been determined according to one of the preceding aspects. The sensor 500 may be integrated into the structure of the rotor jacket 300.

Furthermore, the rotor jacket 300 may comprise a protective housing 505 for protecting the sensor system 250. The position of the protective housing 505 may be taken into account when determining the sensor position SP. The protective housing 505 may extend along the measuring line 305, which may run substantially parallel to the rotor axis 235. The protective housing 505 may specifically serve to protect the sensor system 250 from mechanical damage, contamination, or other external influences. In one or some embodiments, the protective housing 505 is a drop grid. When the harvested material falls through the drop grid, it may be detected by a sensor 500 of the sensor system 250, thereby ensuring accurate measurement. Components that are not to be detected by the sensor 500 may be filtered out by the protective housing 505 and processed further in the separating device 225. The rotor jacket 300 may have a drop step behind the protective housing 505 or the drop grid. The drop step may be a recess in the rotor jacket 300 into which the harvested material may fall and come into contact with the sensor 500.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

List of Reference Numbers

| | |
|---|---|
| 100 | Method |
| S1-S2 | Steps |
| 200 | Harvester |
| 205 | Combine |
| 210 | Front attachment |
| 215 | Inclined conveyor |
| 220 | Threshing device |
| 225 | Separating device |
| 225A-225I | Separating zones |
| 230 | Rotor |
| 235 | Rotor axis |
| 240 | Driver's cab |
| 245 | Graphical user interface |
| 250 | Sensor system |
| 255 | Evaluation unit |
| 256 | Processor |
| 257 | Memory |
| 258 | Communication interface |
| 259 | Driver assistance system |
| 300 | Rotor jacket |
| 305 | Measuring line |
| 310 | Harvested material flow line |
| 400 | Separation function |
| 405 | Separation rate |
| 500 | Sensor |
| 505 | Protective housing |
| V1-V5 | Curves of the separation function |
| Smax | Maximum sensitivity |
| Pmax | Position at which the separation function has the |
| | maximum sensitivity |
| SP | Sensor position |
| M | Measured values |
| VW | Loss value |

1. A method for determining a sensor position in a separating device of a harvester, the method comprising:
accessing a separation function configured to determine a calculated separation;
determining the sensor position of at least one sensor configured to detect an actual separation by: determining a position in the separating device at which the separation function has a maximum sensitivity; and
using the at least one sensor based on the sensor position determined.

2. The method of claim 1, wherein the separating device comprises a rotor and a rotor jacket;
further comprising providing a measuring line, wherein the measuring line is arranged on the rotor jacket of the separating device; and
wherein the sensor position of the at least one sensor is determined by determining the position on the measuring line at which the separation function has the maximum sensitivity.

3. The method of claim 2, wherein the rotor has a rotor axis; and
wherein the measuring line is arranged substantially parallel to the rotor axis.

4. The method of claim 2, wherein the rotor jacket has a drop step;
further comprising determining a drop step position based on the sensor position, wherein the drop step position is determined using a drop function, and wherein the drop function is determined from the separation function.

5. The method of claim 4, further comprising determining whether the sensor position is located in the rotor jacket or outside the rotor jacket.

6. The method of claim 2, wherein a sensor system includes the at least one sensor;
wherein the rotor jacket comprises a protective housing for protecting the sensor system; and
wherein determining the sensor position takes into account a position of the protective housing.

7. The method of claim 1, further comprising determining a harvested material flow line in the separating device, wherein harvested material is separated in sections along the harvested material flow line;
wherein the separation function is based on the harvested material flow line; and
wherein the sensor position is determined by determining the position on the harvested material flow line at which the separation function has a maximum sensitivity.

8. A sensor system configured to detect measured values in a separating device of a harvester, the sensor system comprising:
at least one sensor configured to detect an actual separation; and
electronics configured to:
access a separation function configured to determine a calculated separation;
determine sensor position of the at least one sensor by: determining a position in the separating device at which the separation function has a maximum sensitivity; and
use the at least one sensor based on the sensor position determined.

9. The sensor system of claim 8, wherein the separating device comprises a rotor and a rotor jacket;
wherein the electronics are further configured to provide a measuring line, wherein the measuring line is arranged on the rotor jacket of the separating device; and
wherein the electronics are configured to determine the sensor position of the at least one sensor by determining the position on the measuring line at which the separation function has the maximum sensitivity.

10. The sensor system of claim 9, wherein the rotor has a rotor axis; and
wherein the measuring line is arranged substantially parallel to the rotor axis.

11. The sensor system of claim 9, wherein the rotor jacket has a drop step;
wherein the electronics are further configured to determine a drop step position based on the sensor position, wherein the drop step position is determined using a drop function, and wherein the drop function is determined from the separation function.

12. The sensor system of claim 11, wherein the electronics are further configured to determine whether the sensor position is located in the rotor jacket or outside the rotor jacket.

13. The sensor system of claim 9, wherein the rotor jacket comprises a protective housing for protecting the sensor system; and
wherein the electronics are configured to determine the sensor position based on a position of the protective housing.

14. A harvester comprising:
a separating device; and
a sensor system including comprising:
at least one sensor configured to detect an actual separation; and
electronics configured to:
access a separation function configured to determine a calculated separation;
determine sensor position of the at least one sensor by: determining a position in the separating device at which the separation function has a maximum sensitivity; and
use the at least one sensor based on the sensor position determined.

15. The harvester of claim 14, wherein the separating device comprises a rotor and a rotor jacket, wherein the rotor jacket comprises a drop step; and
wherein the rotor jacket comprises a protective housing for protecting the sensor system.

16. The harvester of claim 14, wherein the separating device comprises a rotor and a rotor jacket;
wherein the electronics are further configured to provide a measuring line, wherein the measuring line is arranged on the rotor jacket of the separating device; and
wherein the electronics are configured to determine the sensor position of the at least one sensor by determining the position on the measuring line at which the separation function has the maximum sensitivity.

17. The harvester of claim 16, wherein the rotor has a rotor axis; and
wherein the measuring line is arranged substantially parallel to the rotor axis.

18. The harvester of claim 16, wherein the rotor jacket has a drop step;
wherein the electronics are further configured to determine a drop step position based on the sensor position, wherein the drop step position is determined using a drop function, and wherein the drop function is determined from the separation function.

19. The harvester of claim 18, wherein the electronics are further configured to determine whether the sensor position is located in the rotor jacket or outside the rotor jacket.

20. The harvester of claim 16, wherein the rotor jacket comprises a protective housing for protecting the sensor system; and
wherein the electronics are configured to determine the sensor position based on a position of the protective housing.
